(19) United States
(12) Patent Application Publication
(10) Pub. No.: US 2013/0057237 A1
(43) Pub. Date: Mar. 7, 2013

(54) MULTI-PHASE SWITCHING REGULATOR AND DROOP CIRCUIT THEREFOR

(71) Applicants: An-Tung Chen, Pingzhen City (TW); Yuan-Wen Hsiao, Taichung City (TW); Yi-Cheng Wan, Taoyuan City (TW)

(72) Inventors: An-Tung Chen, Pingzhen City (TW); Yuan-Wen Hsiao, Taichung City (TW); Yi-Cheng Wan, Taoyuan City (TW)

(73) Assignee: Richtek Technology Corporation, R.O.C.

(21) Appl. No.: 13/226,145

(22) Filed: Sep. 6, 2011

(51) Int. Cl. G05F 1/00; G05F 1/10

(52) U.S. Cl. 323/271; 323/293

(57) ABSTRACT

The present invention discloses a multi-phase switching regulator and a droop circuit therefor. The droop circuit includes: multiple first resistors, which are coupled to corresponding phase nodes respectively to sense current through the phase nodes; a second resistor, which is coupled to the multiple first resistors; an error amplifier circuit, which has an inverting input end and a non-inverting input end, wherein the inverting input end is coupled to the second resistor and an output end of the error amplifier circuit, and the non-inverting input end is coupled to an output node; and a droop capacitor, which is coupled between the second resistor and the output node; wherein the droop circuit provides the droop signal according to a voltage drop across the second resistor or current through the second resistor.

### BACKGROUND OF THE INVENTION

1. Field of Invention

The present invention relates to a multi-phase switching regulator and a droop circuit therefor; particularly, it relates to such multi-phase switching regulator and droop circuit which can sense a total current generated by multiple switch sets and adjust an output voltage accordingly.

2. Description of Related Art

FIG. 1 shows a schematic diagram of a multi-phase switching regulator disclosed by U.S. Pat. No. 6,683,441. As shown in FIG. 1, a summing circuit 25 includes two resistors having the same resistance Rp. Each of the two resistors has one end connected to a corresponding phase node, and the other end connected to a summing node 26 in common. An amplifier circuit includes an operational amplifier A1, which has an inverting input connected to the summing node 26, and a non-inverting input connected to an output voltage Vout. A resistor Rcs (having a resistance Rcs), which is connected in parallel with a capacitor Ccs (having a capacitance Ccs), sets the gain of the operational amplifier A1. When so arranged, the output voltage Vcs produced by the operational amplifier A1 is given by:

$${V}_{cs} = {V}_{out} - \frac{{R}_{cs} {R}_{1} ( 1 + s \frac{L}{{R}_{1}} )}{{R}_{p} ( 1 + {sC}_{cs} {R}_{cs} )} {I}_{out}$$

where L is the inductance of the inductor; R1 is the parasitic resistance of the inductor; s is a variable of Laplace Transform, and Iout is the total output current. If the time constant Ccs*Rcs is made substantially equal to the time constant L/R1 of the inductor, and the output voltage Vout term is subtracted from the output Vcs of the operational amplifier A1 by a summing circuit 30, which receives Vcs at one input, Vout at another input and produces a droop voltage Vdroop given by:

$${V}_{droop} = {V}_{cs} - {V}_{out} = - \frac{{R}_{cs} {R}_{1}}{{R}_{p}} {I}_{out}$$

Thus, when the time constants Ccs*Rcs and L/R1 are made substantially equal, Vdroop is directly proportional to the total output current Iout. The droop voltage Vdroop may be used to provide various functions. For one example, over current protection (OCP) can be achieved by detecting the total current. For another example, in some applications it is required to control the relationship between the output current and the output voltage. In such case, the output voltage Vout can be adjusted according to the droop voltage Vdroop, to achieve the so-called droop control.

The aforementioned prior art requires a large capacitance Ccs and a large resistance Rcs, so the capacitor and resistor can not be integrated in an integrated circuit (IC) chip, and the IC chip needs to be provided with pins for connecting with the capacitor and the resistor. Certainly, this will increase the cost.

FIG. 2 shows a schematic diagram of a droop circuit disclosed by U.S. Pat. No. 7,064,528. As shown in FIG. 2, multiple phase nodes PH1-PHN are coupled to corresponding resistors R1-RN respectively, and the other ends of the resistors are coupled to a non-inverting input of an operational amplifier A2 in common. The output voltage Vout is coupled to an inverting input of the operational amplifier A2 via a resistor RA. A capacitor CA is coupled between the non-inverting input of the operational amplifier A2 and the output voltage Vout. A feedback resistor RC is coupled between the non-inverting input of the operational amplifier A2 and the output voltage Vout. A capacitor CB is coupled between the output voltage Vout and an output end of the operational amplifier A2. The droop voltage Vdroop is the voltage between the output end of the operational amplifier A2 and the output voltage Vout.

Similarly, the droop voltage Vdroop may be set proportional to a total output current (not shown) by proper settings of various parameters of the devices of the droop circuit, such that the droop voltage Vdroop may provide functions such as OCP, droop control, or serve for other purposes.

FIG. 3 shows a schematic diagram of a droop circuit disclosed by US Publication No. 2009/0051334. As shown in FIG. 3, multiple phase nodes PH1-PHN are coupled to corresponding resistors RPH1-RPHN respectively, and the other ends of the resistors are coupled to a non-inverting input of an amplifier 520. The output voltage Vout is coupled to an inverting input of the amplifier 520 via a resistor RCS. A capacitor C1 is coupled between the non-inverting input of the amplifier 520 and the output voltage Vout. An output end of the amplifier 520 generates a droop current as below:

$${I}_{droop} = \frac{\frac{{I}_{out} \times DCR}{N}}{RCS}$$

wherein N is a number of the phase nodes; Iout is the total output current; DCR is a parasitic resistance of each inductor L1-LN. The droop current Idroop is proportional to the total output current Iout, so it can be used for functions such as OCP and droop control.

In the aforementioned prior arts shown in FIGS. 2 and 3, each phase node needs to be coupled to one resistor, and the other end of the resistor must be coupled to the non-inverting input (high impedance terminal) of the amplifier, so that the relationships among various parameters are correct to obtain the information of the total current. Besides, the output voltage Vout must be connected to the inverting input of the amplifier through a resistor, so the amplifier cannot be directly connected to the output voltage Vout. These arrangements will limit the design flexibility of the prior art circuits.

In view of above, to overcome the drawbacks in the prior art, the present invention proposes a multi-phase switching regulator and a droop circuit therefor, which reduces the number of pins of the IC chip and provides a higher design flexibility for the circuit.

### SUMMARY OF THE INVENTION

The first objective of the present invention is to provide a multi-phase switching regulator.

The second objective of the present invention is to provide a droop circuit for use in a multi-phase switching regulator.

To achieve the objectives mentioned above, from one perspective, the present invention provides a multi-phase switching regulator, including: a plurality of switch sets, which generate an output voltage at an output node, wherein each switch set includes at least one power switch and a phase node, and each switch set receives a corresponding driving signal to operate the corresponding at least one power switch thereof for generating the output voltage; a plurality of output inductors, which are coupled between the phase nodes and the output node respectively; a pulse width modulation (PWM) circuit, which generates a plurality of PWM signals to control the plurality of switch sets; and a droop circuit for providing a droop signal, the droop signal being related to a sum of currents through the phase nodes, the droop circuit including: a plurality of first resistors, which are coupled to the phase nodes respectively to sense currents through the phase nodes respectively; a second resistor, which is coupled to the plurality of first resistors; an error amplifier circuit, which has an inverting input end and a non-inverting input end, wherein the inverting input end is coupled to the second resistor and an output end of the error amplifier circuit, and the non-inverting input end is coupled to the output node; and a droop capacitor, which is coupled between the second resistor and the output node; wherein the droop circuit provides the droop signal according to a voltage drop across the second resistor or a current through the second resistor.

From another perspective, the present invention provides a droop circuit for use in a multi-phase switching regulator, including: a plurality of first resistors, which are coupled to corresponding phase nodes respectively to sense currents through the corresponding phase nodes; a second resistor, which is coupled to the plurality of first resistors; an error amplifier circuit, which has an inverting input end and a non-inverting input end, wherein the inverting input end is coupled to the second resistor and an output end of the error amplifier circuit, and the non-inverting input end is coupled to an output node; and a droop capacitor, which is coupled between the second resistor and the output node; wherein the droop circuit provides the droop signal according to a voltage drop across the second resistor or a current through the second resistor.

In one embodiment, the current through the second resistor and the voltage drop across the second resistor preferably has a relationship below:

$${I}_{x} = \frac{{V}_{cx}}{{R}_{x}} = \frac{{I}_{L 1} ( {sL}_{1} + {DCR}_{1} ) - {V}_{cx}}{{R}_{p 1}} + \frac{{I}_{L 2} ( {sL}_{2} + {DCR}_{2} ) - {V}_{cx}}{{R}_{p 2}} + ⋯ + \frac{{I}_{Ln} ( {sL}_{n} + {DCR}_{n} ) - {V}_{cx}}{{R}_{pn}} - {sC}_{x} {V}_{cx}$$

wherein Iₓ is the current through the second resistor; Rₓ and V_{cx} are a resistance and the voltage drop of the second resistor respectively; I_{L1}, I_{L2}, and I_{Ln} are inductor currents through the phase nodes respectively; L₁, L₂, and Lₙ are output inductances of the output inductors respectively; DCR₁, DCR₂, and DCRₙ are parasitic resistances of the output inductors respectively; Rₚ₁, Rₚ₂, and Rₚₙ are resistances of the first resisters respectively; Cₓ is a capacitance of the droop capacitor; s is a variable of the Laplace Transform; and n is a number of the phase nodes.

In another embodiment, the plurality of output inductors preferably have the same inductance L and the same parasitic resistance DCR, and the plurality of first resistors have the same resistance Rₚ; the current through the second resistor and the voltage drop across the second resistor having a relationship below:

$$\frac{{V}_{cx}}{{R}_{x}} = \frac{{I}_{total} \cdot ( sL + DCR ) - {nV}_{cx}}{{R}_{p}} - {sC}_{x} {V}_{cx}$$

wherein Iₜₒₜₐₗ is a sum of currents through the phase nodes.

In yet another preferable embodiment, a parameter K is set as:

$$\frac{1 + s \frac{L}{DCR}}{\frac{{R}_{p}}{{R}_{x}} + n + {sC}_{x} {R}_{P}} = \frac{1}{K}$$

and the capacitance Cₓ of the droop capacitor and the resistance Rₓ of the second resistor are:

$${C}_{x} = \frac{K \cdot L}{DCR \cdot {R}_{P}}$$

$${R}_{x} = \frac{{R}_{P}}{K - n}$$

respectively.

The objectives, technical details, features, and effects of the present invention will be better understood with regard to the detailed description of the embodiments below.

### BRIEF DESCRIPTION OF THE DRAWINGS

FIG. 1 shows a schematic diagram of a multi-phase switching regulator disclosed by U.S. Pat. No. 6,683,441.

FIG. 2 shows a schematic diagram of a droop circuit disclosed by U.S. Pat. No. 7,064,528.

FIG. 3 shows a schematic diagram of a droop circuit disclosed by US Publication No. 2009/0051334.

FIG. 4 shows an embodiment of the present invention.

FIG. 5 shows a more specific embodiment of a droop circuit 20 of the present invention.

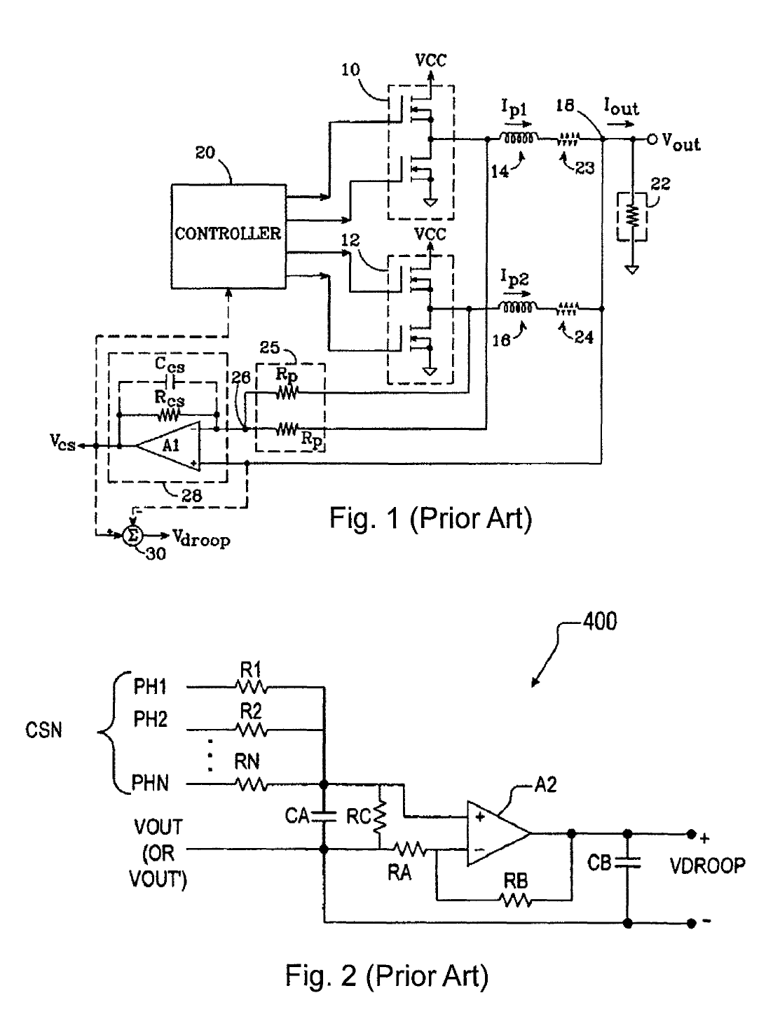

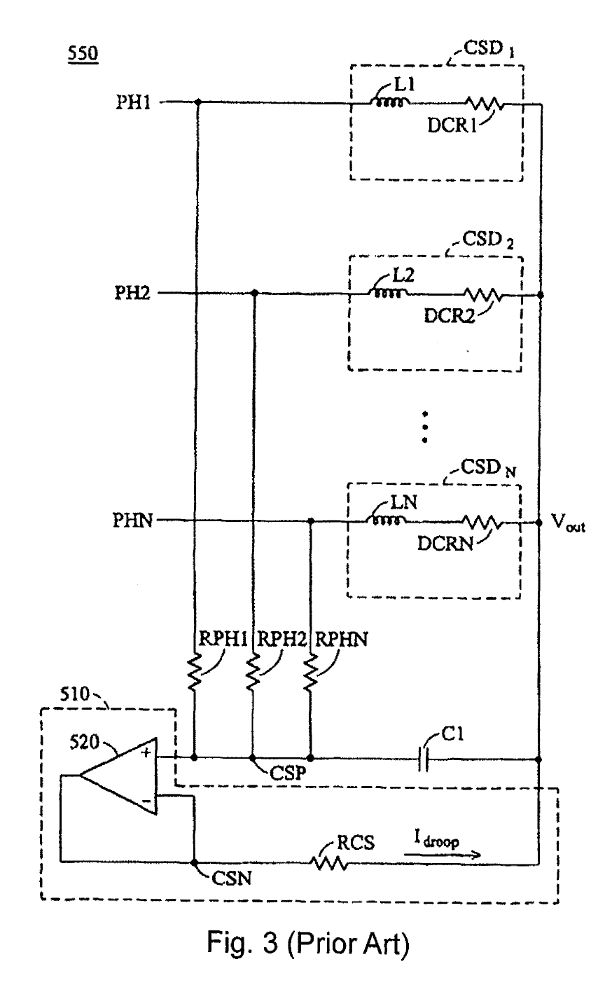

### DESCRIPTION OF THE PREFERRED EMBODIMENTS

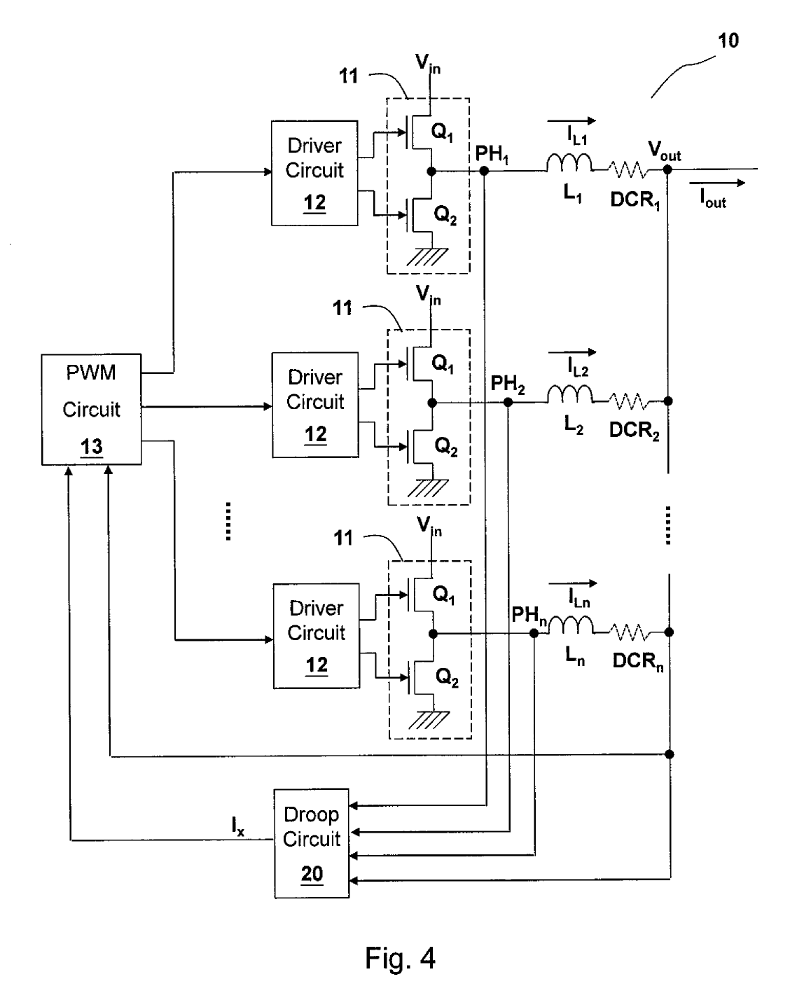

Please refer to FIG. 4 for an embodiment of the present invention. As shown in the figure, a multi-phase switching regulator 10 includes multiple switch sets 11, multiple output inductors L₁-Lₙ (having inductances L₁-Lₙ respectively), multiple driver circuits 12, a PWM circuit 13, and a droop circuit 20. The PWM circuit 13 generates multiple PWM signals according to an output voltage Vₒᵤₜ and a droop current Iₓ, and the multiple PWM signals are inputted to multiple driver circuits 12 respectively, such that the driver circuits 12 generate respective driver signals to operate corresponding switch sets 11. The function of a driver circuit 12 is to provide a driver signal with a voltage level high enough to driver the corresponding switch set 11. If the PWM circuit 13 is able to generate signals with a voltage level high enough to driver the switch sets 11, the diver circuit 12 may be omitted (or integrated in the PWM circuit 13). Each switch set 11 includes for example but not limited to an upper switch Q1 and a lower switch Q2 (the lower switch Q2 may be replaced by a diode), and each switch set 11 converts an input voltage Vin to the output voltage Vout according to the corresponding driver signal, wherein each switch set 11 includes corresponding phase nodes PH₁, PH₂, . . . , or PHₙ. The multiple output inductors L₁-Lₙ have inductances L₁-Lₙ and parasitic resistances DCR₁-DCRₙ respectively. The droop circuit 20 is coupled to the multiple phase nodes PH₁-PHₙ to sense currents through the phase nodes for providing the aforementioned droop current Iₓ as a droop signal, and this droop signal for example may be provided to the PWM circuit 13 (as shown in the figure), or to other circuits such as a load circuit (not shown). The droop current is related to a sum of the currents through the phase nodes PH₁-PHₙ.

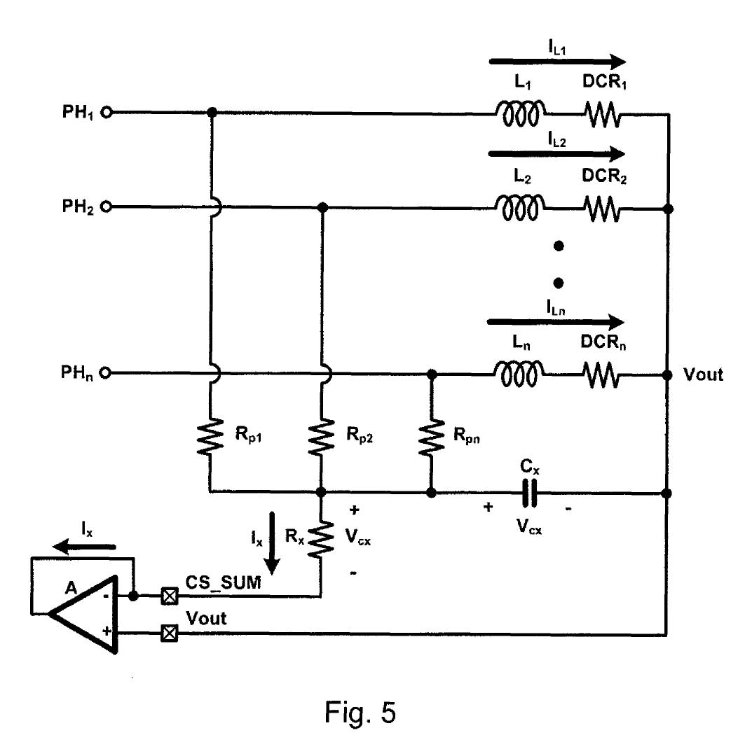

FIG. 5 shows a more specific embodiment of the droop circuit 20. As shown in the figure, the droop circuit 20 includes: multiple first resistors Rₚ₁-Rₚₙ (having resistances Rₚ₁-Rₚₙ respectively), a second resistor Rₓ (having a resistance Rₓ), an error amplifier circuit A, and a droop capacitor Cₓ (having a capacitance Cₓ). The multiple first resistors Rₚ₁-Rₚₙ respectively are coupled to the corresponding phase nodes PH₁-PHₙ to sense currents through the phase nodes PH₁-PHₙ respectively. The second resistor Rₓ is coupled between the multiple first resistors and an inverting input end of the error amplifier circuit A (which is a sum current sensing node CS_SUM for sensing the total current). The inverting input end of the error amplifier A is also coupled to an output end of the error amplifier A, besides coupling to the second resistor. A non-inverting input end of the error amplifier A is coupled to the output voltage Vₒᵤₜ. The droop capacitor Cₓ is coupled between the second resistor Rₓ and the output node. The droop circuit 20 provides the droop current Iₓ according to the second resistor Rₓ and a voltage V_{cx} across the second resistor Rₓ, and the droop current Iₓ is related to the sum of currents through the phase nodes PH₁-PHₙ.

More specifically, the voltage drops across the second resistor and the droop capacitor are the same voltage V_{cx}. Therefore the droop current Iₓ through the second resistor is:

$${I}_{x} = \frac{{V}_{cx}}{{R}_{x}} = \frac{{I}_{L 1} ( {sL}_{1} + {DCR}_{1} ) - {V}_{cx}}{{R}_{p 1}} + \frac{{I}_{L 2} ( {sL}_{2} + {DCR}_{2} ) - {V}_{cx}}{{R}_{p 2}} + ⋯ + \frac{{I}_{L n} ( {sL}_{n} + {DCR}_{n} ) - {V}_{cx}}{{R}_{pn}} - {sC}_{x} {V}_{cx}$$

wherein Rₚ₁-Rₚₙ and Rₓ are resistances of the first resistors Rₚ₁-Rₚₙ and the second resistors Rₓ respectively; I_{L1}-I_{Ln} are currents through phase nodes PH₁-PHₙ respectively; L₁-Lₙ are inductances of the output inductors L₁-Lₙ respectively; DCR₁-DCRₓ are parasitic resistances of the output inductors L₁-Lₙ respectively; s is a variable of the Laplace Transform; and n is a number of the switch sets.

Assuming that the multiple inductors L₁-Lₙ have the same inductance L and the same parasitic resistances DCR, and assuming that the first resistors Rₚ₁-Rₚₙ have the same resistance Rₚ, the droop current Iₓ is:

$${I}_{x} = \frac{{V}_{cx}}{{R}_{x}} = \frac{{I}_{total} \cdot ( sL + DCR ) - {nV}_{cx}}{{R}_{p}} - {sC}_{x} {V}_{cx}$$

wherein Iₜₒₜₐₗ is the sum of currents through the phase nodes PH₁-PHₙ.

Assuming a parameter K is set as:

$$\frac{1 + s \frac{L}{DCR}}{\frac{{R}_{p}}{{R}_{x}} + n + {sC}_{x} {R}_{P}} = \frac{1}{K}$$

such that the term Iₜₒₜₐₗ may be simplified to:

$$\frac{{I}_{total} \cdot DCR}{K} = {V}_{cx}$$

That is, either the voltage V_{cx} across the second resistor Rₓ or the droop current Iₓ (=V_{cx}/Rₓ, wherein Rₓ is a known value) may be used to provide information relating to the total current. According to the value K, the capacitance Cₓ of the droop capacitor Cₓ and the resistance Rₓ of the second resistor Rₓ may be set as:

$${C}_{x} = \frac{K \cdot L}{DCR \cdot {R}_{P}}$$

$${R}_{x} = \frac{{R}_{P}}{K - n}$$

respectively.

The present invention is advantageous over the prior art U.S. Pat. No. 6,683,441 in that, the present invention does not need to provide pins for coupling to the external capacitor Ccs and resistor Rcs as the prior art does, so the present invention has a lower cost and can be applied in a wider range of applications.

In comparison with the prior art U.S. Pat. No. 7,064,528 and US Publication No. 2009/0051334, the present invention is advantageous in that, the non-inverting input end of the error amplifier A can be directly connected to the output voltage Vout, but all the aforementioned prior art circuits need to be connected to the output voltage Vout through a resistor. The control IC of the switching regulator basically needs a pin for coupling to the output voltage Vout, so the pin coupling to the output voltage Vout has already existed in the IC. Because the present invention does not need to be connected to the output voltage Vout through a resistor, the present invention can reduce the number of pins to decrease the manufacturing cost, unlike the prior art circuits which need an additional pin for coupling to the resistor RA or Rcs. (That is, the prior art circuits need three pins for the two input ends of the operational amplifier and the output voltage Vout, while the present invention need only two pins for the node CS_SUM and the output voltage Vout).

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, as shown in FIG. 4, the droop current Iₓ is provided to the PWM circuit 13 as the droop signal, but as aforementioned, the voltage V_{cx} across the second resistor Rₓ may also be used to provide information related to the total current, that is, the voltage V_{cx} across the second resistor Rₓ may be provided to the PWM circuit 13 as the droop signal. For another example, a device which does not substantially influence the primary function of a signal can be inserted between any two devices in the shown embodiments, such as a switch. In view of the foregoing, the spirit of the present invention should cover all such and other modifications and variations, which should be interpreted to fall within the scope of the following claims and their equivalents.

What is claimed is:

1. A multi-phase switching regulator, comprising:
a plurality of switch sets, which generate an output voltage at an output node, wherein each switch set includes at least one power switch and a phase node, and each switch set receives a corresponding driving signal to operate the corresponding at least one power switch thereof for generating the output voltage;
a plurality of output inductors, which are coupled between the phase nodes and the output node respectively;
a pulse width modulation (PWM) circuit, which generates a plurality of PWM signals to control the plurality of switch sets; and
a droop circuit for providing a droop signal, the droop signal being related to a sum of currents through the phase nodes, the droop circuit including:
a plurality of first resistors, which are coupled to the phase nodes respectively to sense currents through the phase nodes respectively;
a second resistor, which is coupled to the plurality of first resistors;
an error amplifier circuit, which has an inverting input end and a non-inverting input end, wherein the inverting input end is coupled to the second resistor and an output end of the error amplifier circuit, and the non-inverting input end is coupled to the output node; and
a droop capacitor, which is coupled between the second resistor and the output node;
wherein the droop circuit provides the droop signal according to a voltage drop across the second resistor or a current through the second resistor.

2. The multi-phase switching regulator of claim 1, wherein the current through the second resistor and the voltage drop across the second resistor has a relationship below:
$${I}_{x} = \frac{{V}_{cx}}{{R}_{x}} = \frac{{I}_{L 1} ( {sL}_{1} + {DCR}_{1} ) - {V}_{cx}}{{R}_{p 1}} + \frac{{I}_{L 2} ( {sL}_{2} + {DCR}_{2} ) - {V}_{cx}}{{R}_{p 2}} + ⋯ + \frac{{I}_{L n} ( {sL}_{n} + {DCR}_{n} ) - {V}_{cx}}{{R}_{pn}} - {sC}_{x} {V}_{cx}$$
wherein Iₓ is the current through the second resistor; Rₓ and V_{cx} are a resistance and the voltage drop of the second resistor respectively; I_{L1}, I_{L2}, and I_{Ln} are inductor currents through the phase nodes respectively; L₁, L₂, and Lₙ are inductances of the output inductors respectively; DCR₁, DCR₂, and DCRₓ are parasitic resistances of the output inductors respectively; Rₚ₁, Rₚ₂, and Rₚₙ are resistances of the first resisters respectively; Cₓ is a capacitance of the droop capacitor; s is a variable of the Laplace Transform; and n is a number of the switch sets.

3. The multi-phase switching regulator of claim 2, wherein the plurality of output inductors have the same inductance L and the same parasitic resistance DCR, and the plurality of first resistors have the same resistance Rₚ, and wherein the current through the second resistor and the voltage drop across the second resistor has a relationship below:
$$\frac{{V}_{cx}}{{R}_{x}} = \frac{{I}_{total} \cdot ( sL + DCR ) - {nV}_{cx}}{{R}_{p}} - {sC}_{x} {V}_{cx}$$
wherein Iₜₒₜₐₗ is the sum of currents through the phase nodes.

4. The multi-phase switching regulator of claim 3, wherein a parameter K is set as:
$$\frac{1 + s \frac{L}{DCR}}{\frac{{R}_{p}}{{R}_{x}} + n + {sC}_{x} {R}_{P}} = \frac{1}{K}$$
and the capacitance Cₓ of the droop capacitor and the resistance Rₓ of the second resistor are:
$${C}_{x} = \frac{K \cdot L}{DCR \cdot {R}_{P}}$$
$${R}_{x} = \frac{{R}_{P}}{K - n}$$
respectively.

5. A droop circuit comprising:
a plurality of first resistors, which are coupled to corresponding phase nodes respectively to sense currents through the corresponding phase nodes;
a second resistor, which is coupled to the plurality of first resistors;
an error amplifier circuit, which has an inverting input end and a non-inverting input end, wherein the inverting input end is coupled to the second resistor and an output end of the error amplifier circuit, and the non-inverting input end is coupled to an output node; and
a droop capacitor, which is coupled between the second resistor and the output node;
wherein the droop circuit provides the droop signal according to a voltage drop across the second resistor or a current through the second resistor.

6. The droop circuit of claim 5, wherein the current through the second resistor and the voltage drop across the second resistor has a relationship below:
$${I}_{x} = \frac{{V}_{cx}}{{R}_{x}} = \frac{{I}_{L 1} ( {sL}_{1} + {DCR}_{1} ) - {V}_{cx}}{{R}_{p 1}} + \frac{{I}_{L 2} ( {sL}_{2} + {DCR}_{2} ) - {V}_{cx}}{{R}_{p 2}} + ⋯ + \frac{{I}_{L n} ( {sL}_{n} + {DCR}_{n} ) - {V}_{cx}}{{R}_{pn}} - {sC}_{x} {V}_{cx}$$
wherein Iₓ is the current through the second resistor; Rₓ and V_{cx} are a resistance and the voltage drop of the second resistor respectively; I_{L1}, I_{L2}, and I_{Ln} are inductor currents through the phase nodes respectively; L₁, L₂, and Lₙ are output inductances of the output inductors respectively; DCR₁, DCR₂, and DCRₙ are parasitic resistances of the output inductors respectively; Rₚ₁, Rₚ₂, and Rₚₙ are resistances of the first resisters respectively; Cₓ is a capacitance of the droop capacitor; s is a variable of the Laplace Transform; and n is a number of the phase nodes.

7. The droop circuit of claim 6, wherein the plurality of output inductors have the same inductance L and the same parasitic resistance DCR, and the plurality of first resistors have the same resistance Rₚ; the current through the second resistor and the voltage drop across the second resistor having a relationship below:
$$\frac{{V}_{cx}}{{R}_{x}} = \frac{{I}_{total} \cdot ( sL + DCR ) - {nV}_{cx}}{{R}_{p}} - {sC}_{x} {V}_{cx}$$
wherein Iₜₒₜₐₗ is a sum of currents through the phase nodes.

8. The droop circuit of claim 7, wherein a parameter K is set as:
$$\frac{1 + s \frac{L}{DCR}}{\frac{{R}_{p}}{{R}_{x}} + n + {sC}_{x} {R}_{P}} = \frac{1}{K}$$
and the capacitance Cₓ of the droop capacitor and the resistance Rₓ of the second resistor are:
$${C}_{x} = \frac{K \cdot L}{DCR \cdot {R}_{P}}$$
$${R}_{x} = \frac{{R}_{P}}{K - n}$$
respectively.
